(19) United States
(12) Patent Application Publication
(10) Pub. No.: US 2017/0187039 A1
(43) Pub. Date: Jun. 29, 2017

(54) POSITIVE ELECTRODE ACTIVE MATERIAL FOR SODIUM SECONDARY BATTERY, AND METHOD FOR PREPARING SAME

(71) Applicant: INDUSTRY-UNIVERSITY COOPERATION FOUNDATION HANYANG UNIVERSITY, Seoul (KR)

(72) Inventors: Yangkook SUN, Seoul (KR); Seungmin OH, Gumi-si, Gyeongsangbuk-do (KR); Jangyeon HWANG, Ansan-si, Gyeonggi-do (KR)

(21) Appl. No.: 15/118,342

(22) PCT Filed: Feb. 12, 2015
(86) PCT No.: PCT/KR2015/001437

§ 371 Date: Aug. 11, 2016

(30) Foreign Application Priority Data
Feb. 12, 2014 (KR) 1020140016252
Feb. 12, 2015 (KR) 1020150021603

(51) Int. Cl. H01M 4/525; H01M 4/505; H01M 4/04; H01M 10/054

(52) U.S. Cl. CPC H01M 4/525; H01M 10/054; H01M 4/505; H01M 4/0471; H01M 2004/021

(57) ABSTRACT

The present invention relates to a positive electrode active material for a sodium secondary battery, and a method for preparing the same. The positive electrode active material for the sodium secondary battery according to the present invention is structurally more stable by replacing a part of the transition metal with Li, and accordingly, the thermal stability and life characteristics of the sodium battery including the positive electrode active material are greatly improved.

### TECHNICAL FIELD

The present invention relates to a positive electrode active material for a sodium secondary battery, and a method for preparing the same.

### BACKGROUND ART

At present, a lithium ion secondary battery using a non-aqueous electrolytic solution prepared by dissolving an electrolytic salt in a non-aqueous solvent and lithium ions moving between an anode and a cathode for charge and discharge is widely used as a secondary battery having a high energy density. The lithium secondary battery is usable for a large-sized secondary battery such as a large-sized power source for vehicles such as an electric vehicle, a hybrid vehicle and the like, or a power source for distributed power storage, and accordingly, demand is increasing. However, a lot of rare metals such as cobalt, nickel, lithium and the like are being used for a lithium secondary battery, and as a result, supply of the rare metals according to increase in demand for a large-sized secondary battery has become a concern.

For this reason, a sodium secondary battery as a non-aqueous electrolyte secondary battery that can address the concern about the supply of a battery material is being considered. The sodium secondary battery is composed of a positive electrode including a positive electrode active material which is capable of being doped and undoped with sodium ions, a negative electrode including a negative electrode active material which is capable of being doped and undoped with sodium ions, and a non-aqueous electrolyte including sodium ions. Since a sodium secondary battery uses sodium which is in abundant supply and has a low cost as a material, a large-sized secondary battery is expected to be supplied in large quantities by putting the same to practical use.

In the sodium secondary battery, the charge and discharge of a battery occur by sodium ions shuttling between a cathode and an anode through an electrolyte like the lithium ions in a lithium secondary battery.

In Japanese Patent Publication No. 2007-287661, a secondary battery including a positive electrode using a composite metal oxide obtained by calcining a raw material having a Na, Mn, and Co composition ratio (Na:Mn:Co) of 0.7:0.5:0.5 and a negative electrode composed of a sodium metal is specifically described. In addition, in Japanese Patent Publication No. 2005-317511, α-NaFeO₂ having a hexagonal (layered rock salt-type) crystal structure is specifically disclosed as a composite metal oxide, and this composite metal oxide is obtained by mixing Na₂O₂ and Fe₃O₄ and calcining the mixture in the air at 600 to 700° C.

However, since a conventional sodium secondary battery is not satisfactory in lifetime characteristics, that is, discharge capacity retention and thermal stability when the charge and discharge is repeated, there is a need for improvement thereof.

### DISCLOSURE

### Technical Problem

For solving problems of the prior art as above, an object of the present invention is to provide a positive electrode active material for a sodium secondary battery in which lifetime characteristics are improved and a new composition is included, a positive electrode for a sodium secondary battery including the same, and the sodium secondary battery including the same.

An object of the present invention is also to provide a method for preparing the positive electrode active material for a sodium secondary battery according to the present invention.

### Technical Solution

For solving problems as above, the present invention provides a positive electrode active material for a sodium secondary battery represented by the following Chemical Formula 1.

NaₓLiₐ[Ni_{y}Fe_{z}Mn_{1-y-z-b}M_{b}]₁₋ₐO₂ [Chemical Formula 1]

(In Chemical Formula 1, M is an element selected from the group consisting of Co, Cr, Zr, Nb, Cu, V, Ti, Zn, Al, Ga, Mg, B, and combinations thereof,

0.8≦x≦1.2, 0.01≦a≦0.1, 0.05≦y≦0.9, 0.05≦z≦0.9, 0≦b≦0.9, and 0.05≦1-y-z-b≦0.9)

The positive electrode active material for a sodium secondary battery according to the present invention is structurally more stable because a migration phenomenon in which Fe³⁺ is changed to Fe⁴⁺ and then moves to a Na⁺ site is prevented by replacing a part of a transition metal with Li, and accordingly, lifetime characteristics and thermal stability are improved.

The positive electrode active material for a sodium secondary battery according to the present invention has a spherical shape having a particle size of 5 to 15 μm, and may exhibit a monodispersed particle size distribution. When a particle size of the positive electrode active material is less than 5 μm, the specific surface area of the positive electrode active material increases. However, since a large amount of binder for binding of the positive electrode active material is required in this case, battery characteristics may be degraded. In contrast, when a particle size of the positive electrode active material is more than 15 μm, battery characteristics may be degraded by a decrease in the specific surface area of the positive electrode active material.

The positive electrode active material for a sodium secondary battery according to the present invention may exhibit 3 peaks in a 2θ range of 30° to 40° in XRD.

The positive electrode active material for a sodium secondary battery according to the present invention may exhibit a main peak (104) in a 2θ range of 40° to 45° in XRD.

The positive electrode active material for a sodium secondary battery according to the present invention may have peaks of 6Li⁺ and 7Li⁺ obtained by cation analysis through time-of-flight secondary ion mass spectrometry.

Equipment for the time-of-flight secondary ion mass spectrometry (TOF-SIMS) is equipment in which SIMS equipment is equipped with a TOF mass analyzer. Specifically, the SIMS equipment is equipment through which chemical composition and surface structure can be obtained by analyzing ions (cations or anions) which are released when a primary ion collides with a surface of an analyte. Meanwhile, the TOF mass analyzer is equipment having a high ion passing rate and excellent mass resolving power so that all ions having mass are measured at the same time, and the TOF-SIMS equipment, through which information about a molecule can be directly obtained by forming a secondary ion of a analytically useful molecule, has high sensitivity to elements as well as molecules and high spatial resolution by a minutely focused ion beam.

The positive electrode active material for a sodium secondary battery according to the present invention may have a peak of Ni³⁺ in a range of 855 to 860 eV in oxidation number analysis by X-ray photoelectron spectroscopy (XPS).

The present invention also provides a method for preparing the positive electrode active material for a sodium secondary battery of the present invention including:

a step of mixing a positive electrode active material precursor for a sodium secondary battery, a sodium compound, and a lithium compound; and

a step of heat treating the mixture.

In the method for preparing the positive electrode active material for a sodium secondary battery of the present invention, the positive electrode active material precursor for a sodium secondary battery may be represented by any one among the following Chemical Formulas 2 to 4.

Ni_{y}Fe_{z}Mn_{1-y-z-b}M_{b}(OH)₂ [Chemical Formula 2]

Ni_{y}Fe_{z}Mn_{1-y-z-b}M_{b}C₂O₄ [Chemical Formula 3]

[Ni_{y}Fe_{z}Mn_{1-y-z-b}M_{b}]₃O₄ [Chemical Formula 4]

(In Chemical Formulas 2 to 4, M is an element selected from the group consisting of Co, Cr, Zr, Nb, Cu, V. Ti, Zn, Al, Ga, Mg, B, and combinations thereof,

0.05≦y≦0.9, 0.05≦z≦0.9, 0≦b≦0.9, and 0.05≦1-y-z-b≦0.9)

In the method for preparing the positive electrode active material for a sodium secondary battery of the present invention, the sodium compound may be selected among sodium carbonate, sodium nitrate, sodium acetate, sodium hydroxide, sodium hydroxide hydrate, sodium oxide, or combinations thereof.

In the method for preparing the positive electrode active material for a sodium secondary battery of the present invention, the sodium compound may be mixed at a molar ratio of 0.8 to 1.5 moles per 1 mole of the positive electrode active material precursor for a sodium secondary battery.

In the method for preparing the positive electrode active material for a sodium secondary battery of the present invention, the lithium compound may be any one selected from the group consisting of lithium nitrate, lithium acetate, lithium carbonate, lithium hydroxide, and combinations thereof.

In the method for preparing the positive electrode active material for a sodium secondary battery of the present invention, in the step of heat treatment, the heat treatment may be performed at 600° C. to 1000° C. When a temperature of the heat treatment is less than 600° C., the temperature may be less than a melting point of a metal included in the positive electrode active material and unreacted metal particles may remain, and when a temperature of the heat treatment is more than 1000° C., lifetime characteristics of a sodium secondary battery including the positive electrode active material may be degraded by progressing heterogeneity of elements of which the positive electrode active material is composed.

The present invention also provides a positive electrode for a sodium secondary battery including the positive electrode active material for a sodium secondary battery of the present invention, and a sodium secondary battery including the same.

### Advantageous Effects

A positive electrode active material for a sodium secondary battery according to the present invention may be structurally more stable by replacing a part of a transition metal with Li, and accordingly, the thermal stability and lifetime characteristics of a sodium battery including the positive electrode active material may be greatly improved.

### DESCRIPTION OF DRAWINGS

FIG. 1 illustrates XRD measurement results of positive electrode active materials prepared in an embodiment and a comparative example of the present invention.

FIG. 2 illustrates TOF-SIMS measurement results of positive electrode active materials prepared in an embodiment and a comparative example of the present invention.

FIG. 3 illustrates an XPS measurement result of positive electrode active materials prepared in an embodiment and a comparative example of the present invention.

FIG. 4 illustrates a measurement result of initial charge and discharge characteristics of a battery including positive electrode active materials prepared in an embodiment and a comparative example of the present invention.

FIGS. 5 to 8 illustrate measurement results of charge and discharge characteristics of a battery including positive electrode active materials prepared in an embodiment and a comparative example of the present invention.

FIGS. 9 and 10 illustrate DSC measurement results of a battery including positive electrode active materials prepared in an embodiment and a comparative example of the present invention.

FIG. 11 illustrates XRD measurement results of positive electrode active materials prepared in an embodiment and a comparative example of the present invention after the charge and discharge.

FIG. 12 illustrates measurement results of rate characteristics of a battery including positive electrode active materials prepared in an embodiment and a comparative example of the present invention.

FIG. 13 illustrates measurement results of lifetime characteristics of a battery including positive electrode active materials prepared in an embodiment and a comparative example of the present invention.

### MODES OF THE INVENTION

Hereinafter, the present invention will be described in more detail with reference to an embodiment. But, the present invention is not limited to the following embodiment.

### <Embodiment> Preparation of a Positive Electrode Active Material

A reactor was filled with 4 l of distilled water, stirred at 1000 rpm while adding ammonia so that a pH inside the reactor was set to 7, and an internal temperature was maintained at 50° C. A 4 M NaOH solution as a second pH adjusting agent was added so that a pH inside the reactor was set to 10.2, and was maintained for 30 minutes. NiSO₄·6H₂O, FeSO₄·7H₂O, and MnSO₄·5H₂O were mixed at an equivalent ratio as an aqueous solution of a transition metal compound, and the mixture was added in the reactor with NH₄OH as a complexing agent to prepare a precursor represented by Ni_{0.25}Fe_{0.25}Mn_{0.5}(OH)₂. The precursor was mixed with sodium carbonate and lithium carbonate, stirred, and then heat treated to prepare a positive electrode active material represented by Na_{1.0}Li_{0.05}[Ni_{0.25}Fe_{0.25}Mn_{0.5}]_{0.95}O₂.

### COMPARATIVE EXAMPLE

A positive electrode active material represented by Na_{1.0}[Ni_{0.25}Fe_{0.25}Mn_{0.5}]O₂ was prepared in the same manner as in the Embodiment, except that the precursor represented by Ni_{0.25}Fe_{0.25}Mn_{0.5}(OH)₂ was mixed with only sodium carbonate.

### <Experimental Example> XRD Measurement

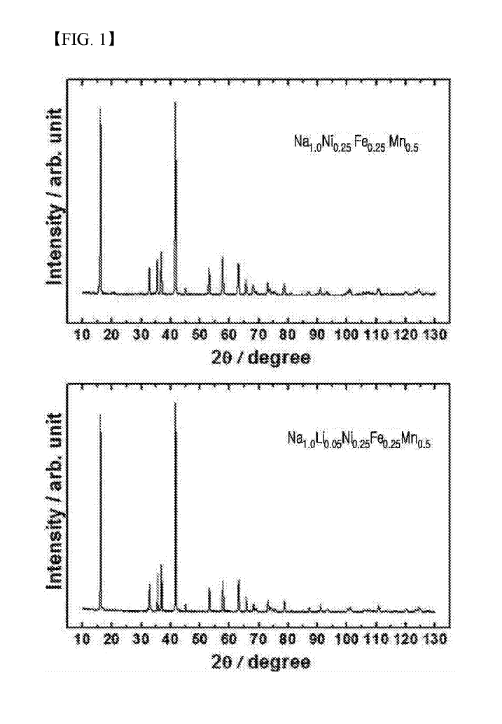

The XRD of the positive electrode active materials prepared in the Embodiment and Comparative Example was measured, results of which were shown in FIG. 1. As shown in FIG. 1, it can be seen that XRD of the positive electrode active material prepared in the embodiment of the present invention exhibits 3 peaks in a 2θ range of 30° to 40°.

### <Experimental Example> TOF-SIMS Measurement

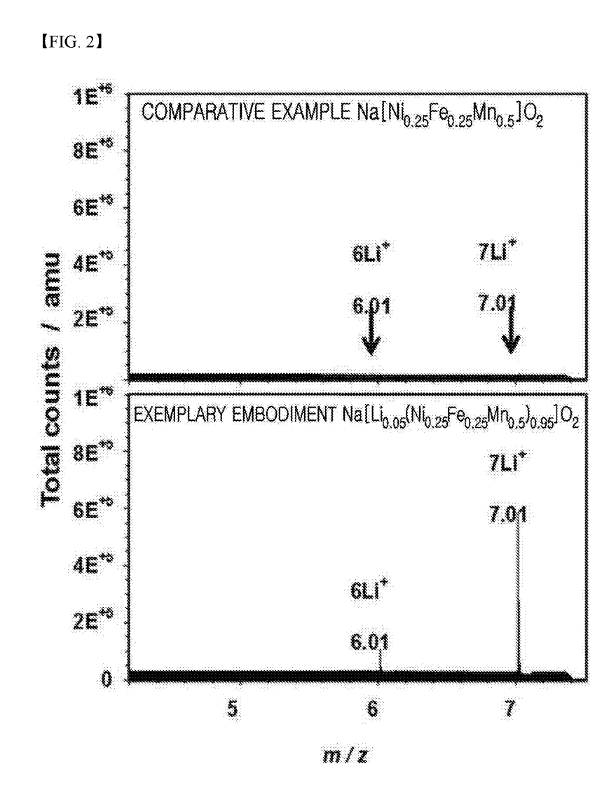

The cation analysis results obtained using Time-of-Flight Secondary Ion Mass Spectrometry (TOF-SIMS) for the positive electrode active materials prepared in the Embodiment and Comparative Example are shown in FIG. 2.

As seen in FIG. 2, it can be seen that the positive electrode active material prepared in the Embodiment of the present invention exhibits peaks of 6Li⁺ and 7Li⁺, whereas the positive electrode active material prepared in the Comparative Example does not exhibit a peak.

### <Experimental Example> X-Ray Photoelectron Spectroscopy (XPS) Measurement

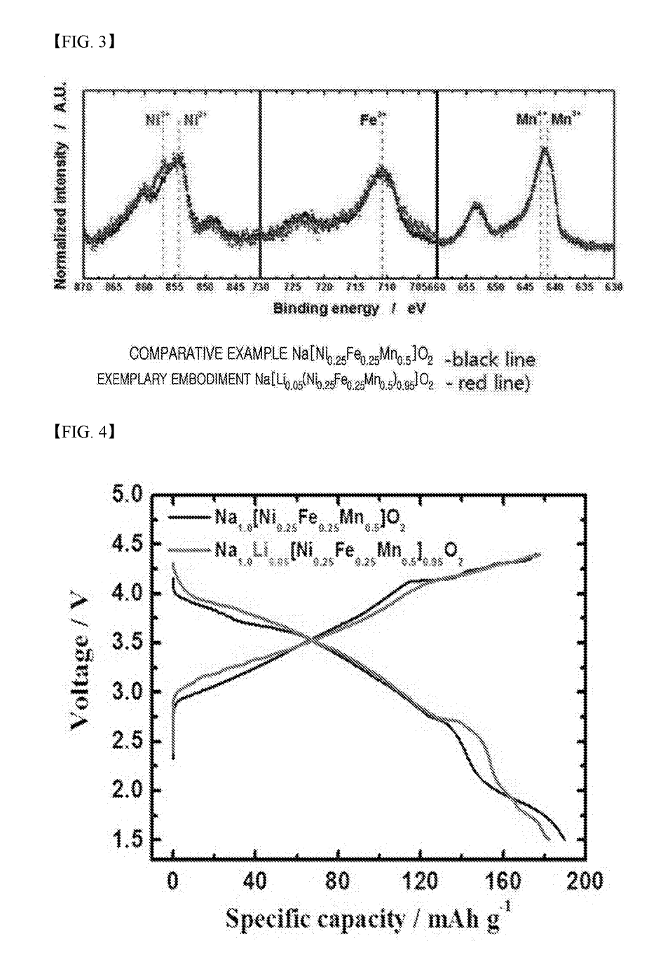

The measurement result of the change in an oxidation number of a transition metal using XPS for the positive electrode active materials prepared in the Embodiment and Comparative Example is shown in FIG. 3.

As shown in FIG. 3, it can be seen that in the case of the positive electrode active material prepared in an embodiment of the present invention, Ni³⁺ is shown in a range of 855 to 860 eV, and Ni is partially changed to Ni³⁺.

### <Preparation Example> Fabrication of a Sodium Battery

The composite metal oxide positive electrode active materials prepared in the Embodiment or Comparative Example, acetylene black (commercially available from Denka Co., Ltd) as an electrically conductive material, and polyvinylidene difluoride (Polyflon: PVDF commercially available from by Kureha Corporation) as a binder were respectively weighted so as to have a composition of positive electrode active material:electrically conductive material:binder=85:10:5 (weight ratio).

Thereafter, first, the composite metal oxide positive electrode active material and acetylene black were thoroughly mixed using an agate mortar, N-methyl-2-pyrrolidone (NMP commercially available from Tokyo Chemical Industry Co., Ltd) was added to this mixture in an appropriate amount, PVDF was then further added thereto, and the resultant was uniformly mixed continuously to obtain a slurry. The obtained slurry was coated, using an applicator, into a thickness of 100 μm on an aluminum foil-based current collector having a thickness of 40 μm. This was then placed in a dryer and thoroughly dried while removing NMP, thereby obtaining a cathode sheet. This cathode sheet 1 was punched using an electrode punching machine so as to have a diameter of 1.5 cm and then sufficiently pressed using a hand press, thereby fabricating a positive electrode.

The fabricated positive electrode was placed in the recess of the lower part of a coin cell (commercially available from Hohsen Corporation) such that the aluminum foil faces down, and subsequently, 1 M NaClO₄/propylene carbonate to which 5 vol % fluoroethylene carbonate (FEC) as a non-aqueous electrolytic solution was added, a polypropylene porous film (thickness: 20 μm) as a separator, and a sodium metal as the negative electrode were then combined therewith, thereby fabricating a sodium secondary battery.

### <Experimental Example> Measurement of Initial Charge and Discharge Characteristics

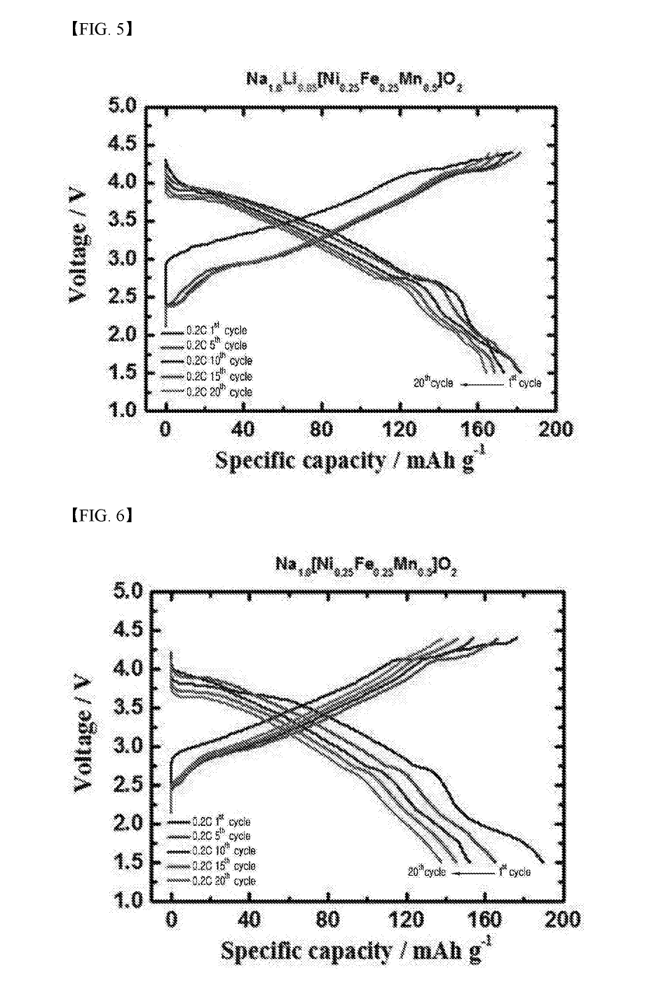

Initial charge and discharge characteristics for individual batteries fabricated in the Preparation Example and including the positive electrode active materials prepared in the Embodiment and Comparative Example were measured, a result of which is shown in FIG. 4.

### <Experimental Example> Measurement of Charge and Discharge Characteristics

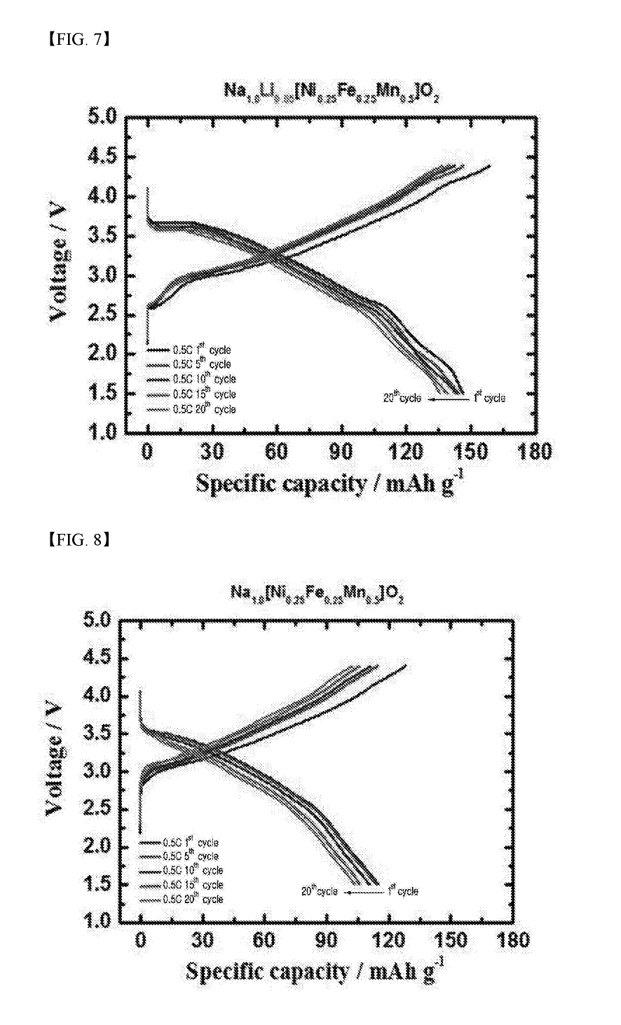

Charge and discharge characteristics for individual batteries fabricated in the Preparation Example and including the positive electrode active materials prepared in the Embodiment and Comparative Example were measured under 0.2 C and 0.5 C conditions, results of which are shown in FIGS. 5 to 8.

### <Experimental Example> Measurement of Thermostability

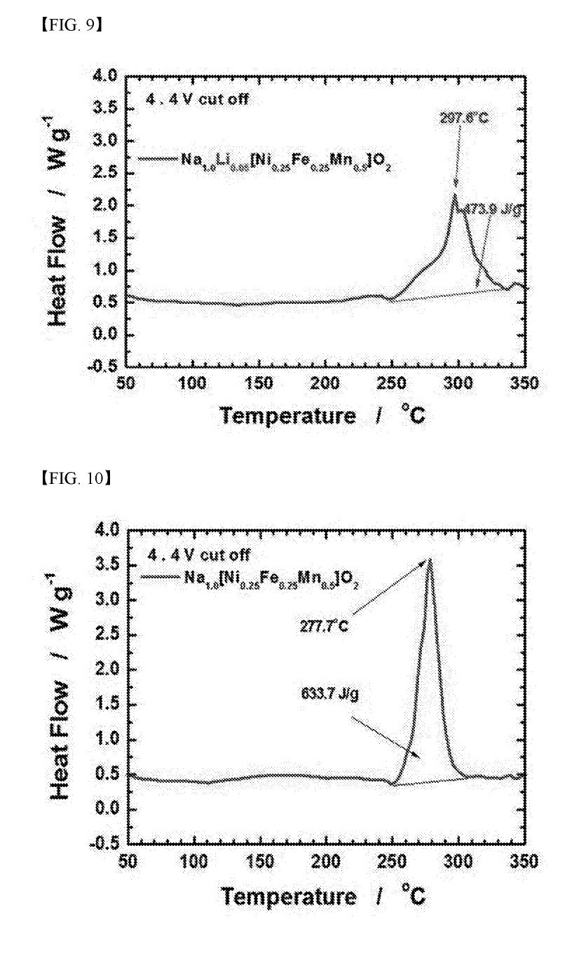

Thermostability for individual batteries fabricated in the Preparation Example and including the positive electrode active materials prepared in the Embodiment and Comparative Example was measured by DSC measurement, results of which are shown in FIGS. 9 and 10.

As shown in FIGS. 9 and 10, in the case of the positive electrode active material including Li according to the Embodiment of the present invention, an ignition temperature is 297.6° C., which is higher than that in the Comparative Example by 20° C. or more, and an amount of heat released during ignition has been decreased by 30% or more. Therefore, it can be seen that in the case of the positive electrode active material including Li according to the Embodiment of the present invention, thermostability is greatly improved.

### <Experimental Example> Measurement of XRD after Charge and Discharge

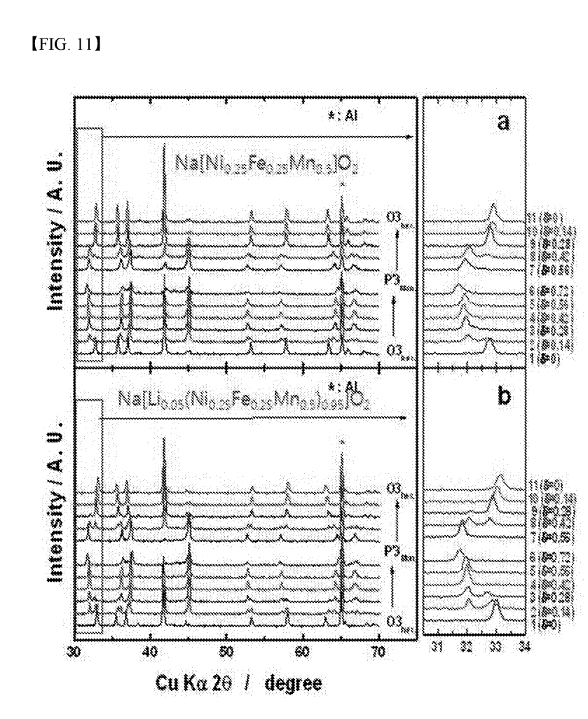

XRD was measured after charging and discharging individual batteries including the positive electrode active materials prepared in the Embodiment and Comparative Example, results of which are shown in FIG. 11.

As seen in FIG. 11, it can be seen that in the case of the positive electrode active material including Li according to the Embodiment of the present invention, an O3 structure is maintained even after charge and discharge, but in the case of the Comparative Example, an O3 crystal structure is not maintained by Fe ion migration, and is changed to a P3 structure.

### <Experimental Example> Measurement of Rate Characteristics

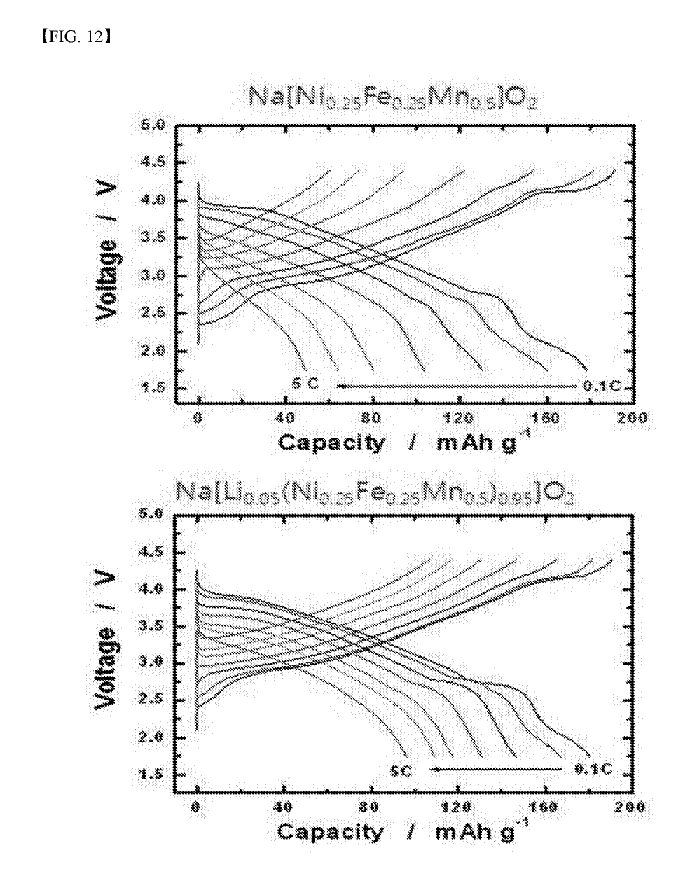

Rate characteristics for individual batteries including the positive electrode active materials prepared in the Embodiment and Comparative Example were measured at room temperature under a 0.1 C charging condition and a 0.1 C to 5 C discharging condition, results of which are shown in FIG. 12.

As seen in FIG. 12, it can be seen that in the case of the positive electrode active material including Li according to the Embodiment of the present invention, rate characteristics are greatly improved compared to on an existing positive electrode active material in which Li is not doped.

### <Experimental Example> Measurement of Lifetime Characteristics

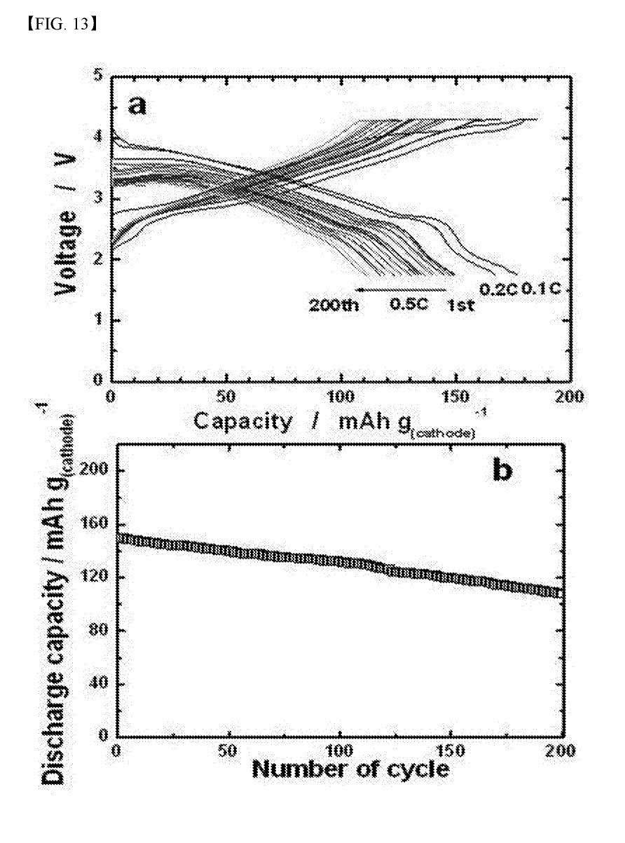

Lifetime characteristics for individual batteries including the positive electrode active materials prepared in the Embodiment and Comparative Example were measured at room temperature under a 0.5 C condition for 200 cycles, results of which were illustrated in FIG. 13.

As seen in FIG. 13, it can be seen that in the case of the positive electrode active material including Li according to the Embodiment of the present invention, 76% capacity retention is obtained for 200 cycles, and lifetime characteristics are greatly improved compared to an existing positive electrode active material in which Li is not doped.

### INDUSTRIAL APPLICABILITY

A positive electrode active material for a sodium secondary battery according to the present invention is structurally more stable by replacing a part of a transition metal with Li, and accordingly, the thermal stability and lifetime characteristics of the sodium battery including the positive electrode active material may be greatly improved.

1. A positive electrode active material for a sodium secondary battery represented by the following Chemical Formula 1.
NaₓLiₐ[Ni_{y}Fe_{z}Mn_{1-y-z-b}M_{b}]₁₋ₐO₂ [Chemical Formula 1]
(wherein M is an element selected from the group consisting of Co, Cr, Zr, Nb, Cu, V, Ti, Zn, Al, Ga, Mg, B, and combinations thereof, and
0.8≦x≦1.2, 0.01≦a≦0.1, 0.05≦y≦0.9, 0.05≦z≦0.9, 0≦b≦0.9, and 0.05≦1-y-z-b≦0.9)

2. The positive electrode active material for a sodium secondary battery according to claim 1,
wherein the positive electrode active material for a sodium secondary battery has a spherical shape having a particle size of 5 to 15 μm, and exhibits a monodispersed particle size distribution.

3. The positive electrode active material for a sodium secondary battery according to claim 1,
wherein the positive electrode active material for a sodium secondary battery exhibits 3 peaks in 2θ range of 30° to 40° in XRD.

4. The positive electrode active material for a sodium secondary battery according to claim 3,
wherein the positive electrode active material for a sodium secondary battery exhibits a main peak (104) in a 2θ range of 40° to 45° in XRD.

5. The positive electrode active material for a sodium secondary battery according to claim 1,
wherein the positive electrode active material for a sodium secondary battery has peaks of 6Li⁺ and 7Li⁺ obtained by cation analysis through time-of-flight secondary ion mass spectrometry.

6. The positive electrode active material for a sodium secondary battery according to claim 1,
wherein the positive electrode active material for a sodium secondary battery has a peak of Ni³⁺ in a range of 855 to 860 eV in oxidation number analysis by X-ray photoelectron spectroscopy (XPS).

7. A method for preparing the positive electrode active material for a sodium secondary battery of claim 1, comprising:
mixing a positive electrode active material precursor for a sodium secondary battery, a sodium compound, and a lithium compound; and
heat treating the mixture.

8. The method for preparing the positive electrode active material for a sodium secondary battery according to claim 7,
wherein the positive electrode active material precursor for a sodium secondary battery is represented by any one among the following Chemical Formulas 2 to 4.
Ni_{y}Fe_{z}Mn_{1-y-z-b}M_{b}(OH)₂ [Chemical Formula 2]
Ni_{y}Fe_{z}Mn_{1-y-z-b}M_{b}C₂O₄ [Chemical Formula 3]
[Ni_{y}Fe_{z}Mn_{1-y-z-b}M_{b}]₃O₄ [Chemical Formula 4]
(wherein M is an element selected from the group consisting of Co, Cr, Zr, Nb, Cu, V, Ti, Zn, Al, Ga, Mg, B, and combinations thereof, and
0.05≦y≦0.9, 0.05≦z≦0.9, 0≦b≦0.9, and 0.05≦1-y-z-b≦0.9)

9. The method for preparing the positive electrode active material for a sodium secondary battery according to claim 7,
wherein the sodium compound is selected among sodium carbonate, sodium nitrate, sodium acetate, sodium hydroxide, sodium hydroxide hydrate, sodium oxide, or combinations thereof.

10. The method for preparing the positive electrode active material for a sodium secondary battery according to claim 7,
wherein the sodium compound is mixed at a molar ratio of 0.8 to 1.5 moles per 1 mole of the positive electrode active material precursor for a sodium secondary battery.

11. The method for preparing the positive electrode active material for a sodium secondary battery according to claim 7,
wherein the lithium compound is any one selected from the group consisting of lithium nitrate, lithium acetate, lithium carbonate, lithium hydroxide, and combinations thereof.

12. The method for preparing the positive electrode active material for a sodium secondary battery according to claim 7,
wherein the heat treating is performed at 600 to 1000° C.

13. A positive electrode for a sodium secondary battery including the positive electrode active material for a sodium secondary battery of claim 1.

14. A sodium secondary battery including the positive electrode for a sodium secondary battery of claim 13.
